(19) United States
(12) Patent Application Publication
(10) Pub. No.: US 2006/0116071 A1
(43) Pub. Date: Jun. 1, 2006

(54) Receiver integrated satellite digital audio radio antenna system

(76) Inventors: Korkut Yegin, Grand Blanc, MI (US); Daniel G. Morris, Ovid, MI (US); Elias H. Ghafari, Rochester Hills, MI (US); Loren M. Thompson, Lapeer, MI (US); William R. Livengood, Grand Blanc, MI (US)

Correspondence Address: DELPHI TECHNOLOGIES, INC., M/C 480-410-202, PO BOX 5052, TROY, MI, 48007, US

(21) Appl. No.: 10/999,386

(22) Filed: Nov. 30, 2004

(51) Int. Cl. H04H 1/00; H04M 1/00

(52) U.S. Cl. 455/3.02; 455/575.7

(57) ABSTRACT

A receiver system for receiving a satellite digital audio radio signal having an antenna module and a receiver. The antenna module is permanently coupled thereto and/or integrated with the receiver.

### TECHNICAL FIELD

The present invention relates generally to antenna systems for satellite digital audio radio service communications and more specifically to an antenna module incorporated into a receiver for satellite digital audio radio service communications.

### BACKGROUND

Communications between terrestrial devices such as radios and earth-orbiting satellites are well known. A commercial application of these satellite systems is satellite digital audio radio service (SDARS). SDARS systems broadcast high quality uninterrupted audio through satellites and earth-based stations. SDARS systems typically include an antenna with a low-noise amplifier and a receiver. The antenna initially receives encoded signals from the satellites and/or terrestrial transmitters. The amplifier, which is conventionally housed within the antenna, amplifies the received signal. The receiver decodes the transmitted signal and provides the signal to the radio.

SDARS antenna is housed external to the receiver and connectable to the receiver via a removable conductor, such as a coaxial cable having adapters on each end. In an automobile environment, for example, the receiver may be located in the trunk area while the antenna is located on the roof. The receiver is then coupled to the antenna via the coaxial cable that is routed throughout the vehicle. The intrinsic properties of the wire degrade the amplitude of the satellite signal that travels from the antenna to the receiver. Accordingly, the amplifier is required in order to compensate for the amplitude losses. As such, the amplifier, the conductor having couplers, and the couplers associated with the receiver and antenna substantially increase manufacturing and overall system costs. Additionally, design time, packaging considerations, and system efficiency are negatively impacted by the requisite components of the conventional system. The above considerations have also inhibited the ability of designers to provide smaller portable SDAR receiving systems.

The embodiments described hereinafter were developed in light of these and other disadvantages of existing SDARS receiving systems.

### SUMMARY

In light of the above disadvantages of conventional systems, a receiver system for receiving satellite digital audio radio signals is disclosed. The receiver system includes a receiver and an antenna module that is permanently coupled and/or integrated with the receiver.

### BRIEF DESCRIPTION OF THE DRAWINGS

FIG. 1 illustrates an instrument panel of a vehicle having an SDARS receiver according to an embodiment of the present invention.

FIG. 2A and 2B illustrates a perspective view of a receiver having an antenna module permanently coupled to the receiver according to an embodiment of the present invention.

FIGS. 3A-3C illustrate a receiver system having an antenna module permanently coupled to a receiver according to an embodiment of the present invention.

FIG. 4 illustrates a receiver system having multiple antenna modules according to an embodiment of the present invention.

### DETAILED DESCRIPTION

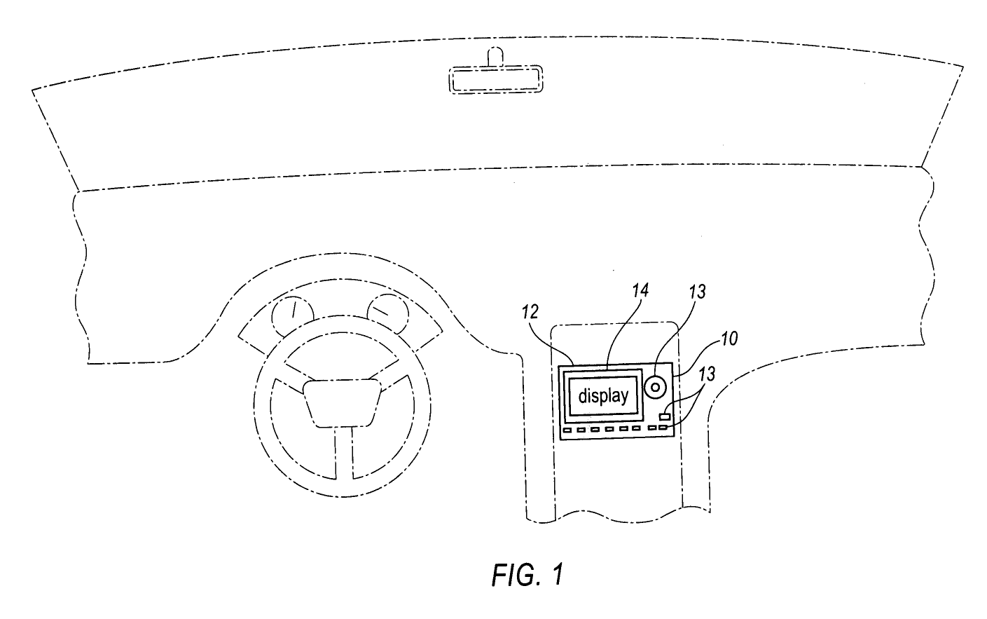

Referring to FIG. 1, a vehicle instrument panel is illustrated that includes a receiver 10. The receiver 10 has an antenna module 14 for receiving SDARS programming. The receiver 10 may include microprocessors and other programmable circuitry that are responsive to programming by a user. As shown, the receiver 10 is capable of being mounted in a vehicle. Additionally, the receiver 10 may be incorporated into other areas of the vehicle such as the center console (not shown), the headrest of a seat (not shown), or any other suitable area within the vehicle. Moreover, the receiver 10 is capable of being mounted in a rooftop of the vehicle and alternatively, in the front, rear, or side window of the vehicle for example. The disclosed locations of the receiver 10 on the vehicle serve as examples only and in no way limit the scope of the invention. The receiver 10 may also be removable from the vehicle by a user for additional convenience in receiving SDARS programming. The receiver 10 has a housing 12 and may include at least one selector 13. The selector 13 enables the user to tune to various SDARS programming channels and program the receiver 10 to automatically tune to specific channels. As illustrated, the receiver 10 may include a display that displays information such as the particular SDARS programming channel, song lists, times, dates, and any other information pertinent to the user. As will be discussed in further detail below, the receiver 10 overcomes the disadvantages of conventional receivers by having the antenna module 14 permanently coupled thereto and/or integrated therewith. Permanent coupling thereto and/or integration therewith of the antenna module 14 to the receiver 10 include the antenna module 14 within the housing 12 and/or externally affixed to the housing 12.

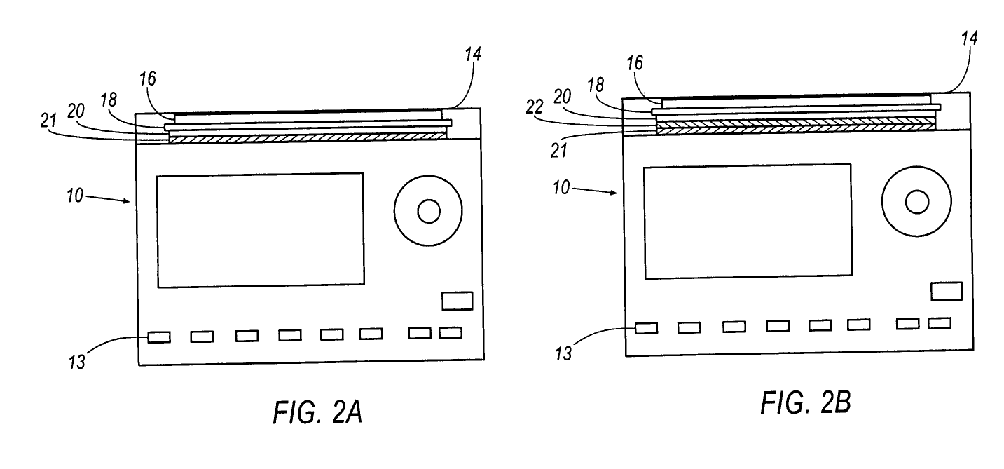

Referring to FIG. 2A and 2B, a receiver system is shown having the antenna module 14 permanently coupled to the receiver 10. The antenna module 14 receives encoded satellite digital audio radio signals from a satellite and/or terrestrial transmitter (not shown). In response, the receiver 10 decodes the signals and provides the signals to a user. The antenna module 14 includes an antenna element 16, a ground plane 18, and an antenna feeder 20. In some embodiments, as shown in FIG. 2B, the antenna module 14 may include an amplifier 22. Unlike conventional systems that require a conductor between the receiver 10 and the antenna module 14, the antenna module 14 is permanently coupled thereto and/or integrated with the receiver 10 through a permanent connection. Specifically, the components within the antenna module 14 (e.g., the antenna element 16, the ground plane 18, and the antenna feeder 20) may be permanently coupled to the receiver 10. In some embodiments, the antenna module 14 may be permanently coupled to the receiver 10 through a printed circuit board (PCB) 21 or alternatively, direct soldering. As illustrated in FIGS. 2A and 2B, the conductor and associated couplings (e.g., adapters) of conventional systems are not required for connecting the components of the antenna module 14 with the receiver 10. The permanent connection between the antenna module 14 and the receiver 10 by way of the circuit board 21 eliminates the need for the conventional conductor and couplings.

Regarding the permanently connected components within the antenna module 14, the antenna element 16 initially receives an encoded signal from the satellite and/or a terrestrial transmitter (not shown). Antenna element 16 may be a quadrifilar helical antenna or a patch antenna. As well-known in the art, the quadrifilar helical antenna and patch antenna typically possess different gain patterns. Thus, depending upon performance requirements, the quadrifilar helical antenna may be preferred over the patch antenna or vice versa. In the case that the antenna element 16 is a quadrifilar helical antenna, a capacitively loaded dielectric may be utilized for frequency tuning purposes. The dielectric may have a dielectric constant in the range of 2.0 to 9.0. As known in the art, the dielectric also reduces the size of the antenna element 16. Furthermore, utilizing a quadrifilar helical antenna enables improved reception of signals transmitted by terrestrial transmitters.

The amplifier 22 (FIG. 2B) amplifies signals received by the antenna element 16. Because the antenna element 16 is located in close proximity to the receiver 10, the amplifier 22 is not required in some embodiments. (e.g., FIG. 2A) Nevertheless, where the amplifier 22 is present, as in FIG. 2B, a less powerful relatively inexpensive amplifier 22 may be utilized. Accordingly, the less powerful inexpensive amplifier 22 is also reduced in size. Specifically, the amplifier may occupy an area less than 900 mm². Additionally, in one embodiment, the amplifier 22 is a low-noise amplifier.

The ground plane 18 provides a radio frequency ground for the antenna element 16. Although the ground plane 18 is shown as a discrete component, the ground plane 18 may be integrated into the antenna element 16 by soldering or any other conventional technique. Alternatively, the housing 12 may serve as a ground plane for the antenna element 16. Integrating the ground plane 18 into the antenna element 16 or the housing 12 further reduces the packaging size of the antenna module 14.

Coupled to the ground plane 18 may be the antenna feeder 20. The feeder 20 energizes the antenna element 16. Where the quadrifilar helical antenna serves as the antenna element 16, the feeder 20 may be a four port hybrid coupler or alternatively a phasing network. As well-known in the art, the four port hybrid coupler and phasing network are capable of energizing the antenna element 16 in phase quadrature.

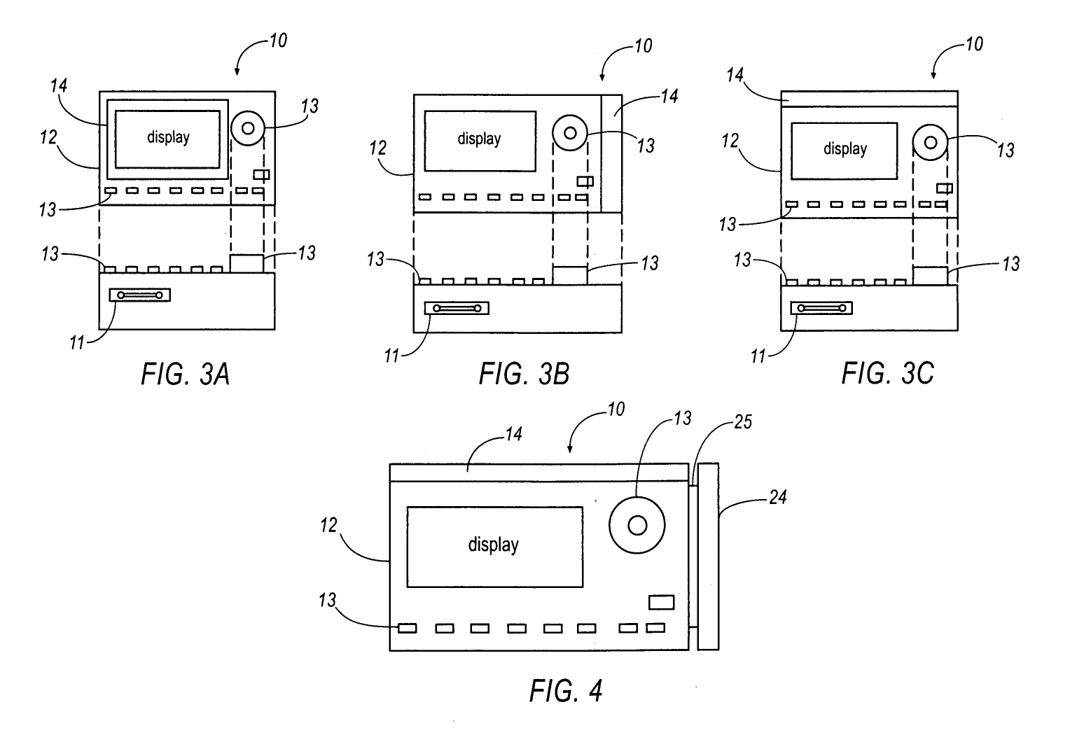

Referring to FIGS. 3A-3C, alternate embodiments of a receiver system are shown that include the receiver 10. As noted above, the receiver 10 includes the antenna module 14 permanently coupled thereto and/or integrated therewith. As illustrated, the receiver 10 may operate as a portable stand-alone unit. Accordingly, the user may receive SDARS programming in virtually any location.

The receiver 10 may also include a port 11. The port 11 provides a connection point between the receiver 10 and other devices such as a power source, a computer, or other receivers. By way of the port 11, the receiver 10 may receive power, data, and software upgrades.

The antenna module 14 may be permanently coupled thereto and/or integrated with the receiver 10 at various locations. The components that comprise the antenna module 14 may be integrated onto a printed circuit board and incorporated into the receiver 10. As shown in FIG. 3A, the antenna module 14 may be integrated adjacent to the display of the receiver 10. FIG. 3B shows the antenna module 14 integrated with a side portion of the receiver 10. FIG. 3C illustrates the antenna module 14 integrated with an upper portion of the receiver 10. The length and/or width of the housing 12 are modifiable by adjusting the specific location of the antenna module 14. This becomes advantageous in that packaging requirements for the receiver 10 may vary from location to location. Modifying the specific location of the antenna module 14 enables the receiver 10 to adapt to virtually any packaging requirement. It should be recognized, however, that the specific locations of the antenna module 14 are by way of example, and do not serve as a limitation to the scope of the present invention. Additionally, in other embodiments to be discussed below, multiple antenna modules may be permanently coupled thereto and/or integrated with the receiver 10.

Referring to FIG. 4, the receiver 10 is shown having multiple antenna modules 14 and 24. In this embodiment, antenna module 14 is permanently coupled to the receiver 10 while antenna module 24 may be externally affixed and removable from the receiver 10. The antenna module 24 is mechanically mounted to the receiver 10 and electrically coupled to the receiver 10 via a conductor 25. Alternatively, the antenna module 24 may be electrically coupled to the receiver 10 via a male/female connection. In yet another embodiment, the antenna module 24 may communicate with the receiver 10 wirelessly. For instance, the antenna module 24 receives SDARS signals from the satellite and/or terrestrial transmitter and sends the SDARS signals to the receiver 10 using a wireless protocol such as blue-tooth or wi-fi.

The antenna module 24 may be mechanically attachable to the receiver 10 by molding a stub (not shown) onto the housing 12 that corresponds in size with an aperture (not shown) that is molded into the antenna module 24. Incorporating multiple antenna modules into the receiver system enables the antenna modules 14 and 24 to operate in a diversity scheme. Typically, the antenna modules 14 and 24 have a plurality of available pre-programmed channels on which to receive satellite signals. Accordingly, the software embedded within the receiver 10 is capable of determining the channels that provide the best reception on each antenna module 14 and 24. The receiver 10 may then utilize those identified channels thereby providing the user with optimum reception. This process of identifying the channels for optimum reception is known as diversity scheme operation.

As noted above, the antenna module 24 may be moveable about the housing 12. For instance, in areas of weak signal reception, the user can pivot the antenna module 24 about the housing 12 thereby improving signal reception. Alternatively, the user may detach the antenna module 24 from the receiver 10 thereby improving signal reception. Where the antenna module 24 is detachable, the patch antenna is typically preferred for use as the antenna element 16 because of the reduced size and gain characteristics of the patch antenna.

As illustrated, the amplifier 22, the antenna element 16 and other operational components may be permanently coupled to the receiver 10. Because the antenna module 14 is permanently coupled to the receiver 10, the use of a conductor and associated couplings that couple the antenna module 14 and the receiver 10 are not required. The elimination of the conductor also reduces the level of signal amplification required. Accordingly, in one embodiment the amplifier 22 is also not needed. Alternatively, where the amplifier 22 is required, a less powerful amplifier may be utilized. Thus, the size of the amplifier and costs associated with the amplifier are reduced. Accordingly, the receiver 10 may operate in a vehicle environment and/or a stand-alone portable SDARS receiving system.

Various other modifications to the present invention may occur to those skilled in the art to which the present invention pertains. Other modifications not explicitly mentioned herein are also possible and within the scope of the present invention. It is the following claims, including all equivalents, which define the scope of the present invention.

What is claimed is:

1. A receiver system for satellite digital audio radio signals comprising:
an antenna module; and
a receiver having said antenna module permanently coupled thereto.

2. A system according to claim 1, wherein the antenna module is permanently coupled to the receiver by a circuit board.

3. A system according to claim 1, wherein the antenna module is permanently coupled to the receiver by soldering.

4. A system according to claim 1 wherein the antenna module further comprises an antenna element.

5. A system according to claim 4, wherein the antenna element is a patch antenna.

6. A system according to claim 4, wherein said antenna element is a quadrifilar helical antenna.

7. A system according to claim 6, wherein said quadrifilar helical antenna further comprises a loaded dielectric having a dielectric constant in the range of 2.0 to 9.0.

8. A system according to claim 1, wherein the antenna module further comprises an amplifier.

9. A system according to claim 1, wherein said antenna module further comprises an antenna feeder.

10. A system according to claim 9, wherein said antenna feeder is a four port hybrid coupler.

11. A system according to claim 1, wherein the antenna module is moveable about said receiver.

12. A system according to claim 1, wherein the receiver further comprises a ground plane for said antenna module.

13. A receiver system for satellite digital audio radio signals comprising:
a receiver having a housing;
a first antenna module integrated within the housing of said receiver; and
a second antenna module externally affixed to the housing of said receiver.

14. A system according to claim 13, wherein said first antenna module further comprises:
an antenna element; and
an amplifier.

15. A system according to claim 14, wherein said antenna element is a quadrifilar antenna.

16. A system according to claim 13, wherein said second antenna module includes a patch antenna.

17. A method of manufacturing a receiver for a satellite digital audio radio signal comprising:
providing the receiver; and
permanently coupling at least one antenna module having an antenna element to the receiver.

18. A method according to claim 17, wherein the antenna element is a quadrifilar helical antenna.

19. A method according to claim 17, wherein the antenna element is a patch antenna.
